(19) United States
(12) Patent Application Publication
(10) Pub. No.: US 2006/0166855 A1
(43) Pub. Date: Jul. 27, 2006

(54) Fragrance delivery system

(76) Inventor: Howard Murad, Marina del Ray, CA (US)

Correspondence Address: KENYON & KENYON LLP, 1500 K STREET N.W., SUITE 700, WASHINGTON, DC, 20005, US

(21) Appl. No.: 11/297,478

(22) Filed: Dec. 9, 2005

Related U.S. Application Data
(60) Provisional application No. 60/646,507, filed on Jan. 25, 2005.

(51) Int. Cl. A61Q 13/00

(52) U.S. Cl. 512/1

(57) ABSTRACT

A fragrance delivery systems for use in personal care and personal hygiene articles, such as perfumes and colognes. The fragrance delivery systems includes (i) a fragrant component; a carboxylic acid or a salt or ester thereof, wherein the carboxylic acid selected from the group consisting of an α-hydroxy acid, a β-hydroxy acid, or a poly-hydroxy acid; (ii) phenoxyethanol; and (iii) ethanol.

### CROSS-REFERENCE TO RELATED APPLICATIONS

This application claims the benefit of U.S. Provisional Application No. 60/646,507 filed 25 Jan. 2005, the content of which is incorporated herein by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The present invention relates to a fragrance delivery systems for use in personal care and personal hygiene articles, such as perfumes and colognes. The fragrance delivery systems comprises (i) a fragrant component; (ii) a carboxylic acid or a salt or ester thereof, wherein the carboxylic acid is selected from the group consisting of an α-hydroxy acid, a β-hydroxy acid, or a poly-hydroxy acid; (iii) phenoxyethanol; and (iv) ethanol.

2. Description of Related Art

Humans have applied scents and fragrances to their skin since antiquity. Originally these aesthetically pleasing materials were commonly isolated in raw form as resins, gums, or essential oils from natural sources such as the bark, roots, leaves, and fruit of indigenous plants. These resins, gums, and oils were directly applied to the body or diluted with water or other solvent, including in some cases, wine. With the advent of modern chemistry, however, the individual components responsible for the aroma of these resins, gums and oils were isolated and characterized.

Fragrant compounds have to be volatile in order to be perceived. Although many fragrant compounds are known to have good substantivity (i.e., they tend to cling to a surface to which they have been applied, in particular the skin, for several hours and can hence be perceived over a period of time), many fragrant compounds are so volatile that their characteristic smell can no longer be perceived after several hours, and in some cases even less time, after being applied to the skin. Accordingly, there is an interest in “fixing” fragrant molecules to the skin so that the fragrant molecules can be released over a prolonged period of time.

U.S. Pat. No. 6,492,323 describes a fragrance delivery system that allegedly is capable of releasing fragrant alcohols upon exposure to light, and in particular daylight.

U.S. Pat. Nos. 5,378,468 and 5,626,852 each to Suffis et al. describes a compositions for contacting the skin, wherein a fragrance is released from a compound forming a component of the composition after application of the composition to the skin, i.e., a, a body activated fragrances

U.S. Pat. No. 5,081,111 to Akimoto et al. describes a preparation for controlled release of an active material obtained by reacting an active material with a copolymer of maleic anhydride and a copolymerizable polyalkylene glycol ether comprising a reaction product obtained by reacting (a) a copolymer consisting essentially of maleic anhydride and at least one polyalkylene glycol ether.

JP 07-179328 describes a composition capable of releasing a moderate aroma for a long period by converting a perfume compound into a derivative of a glycoside, a phosphoric acid ester, an amino acid, or a carboxylic acid derivative.

JP 05-230496 describes a composition that can maintain a constant quality of fragrance prepared by blending one or more perfume components with other perfume components, wherein the whole or part of at least one perfume component is in the form of a precursor that can be converted into the perfume component by decomposition with an acid, and an acid for decomposing the precursor.

WO 96/14827 describes a sustained-release aromatic containing at least one perfume derivative selected from glycosides, phosphates, amino acid derivatives and carboxylic acid derivatives of perfumes. The aromatic is decomposed by a microorganisms such as an indigenous dermal bacterium or yeast to liberate the perfume component and thus emit an aroma.

There is a need in the art, however, for cosmetic formulations that increase the longevity of a fragrance odor, i.e., a cosmetic formulations that release molecules of a fragrant component slowly so that the odor of the fragrant component can be perceived for a longer period of time. The present invention provides such a cosmetic formulation.

### SUMMARY OF THE INVENTION

The present invention relates to a fragrance delivery system comprising (i) a fragrant component; (ii) a carboxylic acid or a salt or ester thereof, wherein the carboxylic acid is selected from the group consisting of an α-hydroxy acid, a β-hydroxy acid, or a poly-hydroxy acid, (iii) phenoxyethanol; and (iv) ethanol. The invention also relates to a cosmetic formulation comprising the fragrance delivery system of the invention and a cosmetically acceptable carrier.

### DETAILED DESCRIPTION OF THE INVENTION

The present invention relates to a fragrance delivery system and a cosmetic formulation comprising the fragrance delivery system and a cosmetically acceptable carrier. The fragrance delivery system comprises (i) a fragrant component; (ii) a carboxylic acid or a salt or ester thereof, wherein the carboxylic acid is selected from the group consisting of an α-hydroxy acid, a β-hydroxy acid, or a poly-hydroxy acid, (iii) phenoxyethanol; and (iv) ethanol. The fragrance delivery system releases the fragrant component over a prolonged period of time.

The phrase “fragrant component,” as used herein means any compound or mixture of compounds that imparts a pleasurable scent, odor, essence, or fragrant characteristic. Typically, to be an effective fragrant component the fragrant component must be volatile. Accordingly, the fragrant component typically comprises molecules that have a molecular weight of less than 200 g/m, preferably less than 150 g/m, and more preferably less than 100 g/m. Fragrant components can be, for example, alcohols, ketones, aldehydes, esters, nitriles, cyclic alkenes, and acyclic alkenes.

Representative fragrant components that are aldehydes include, but are not limited to, citral, citronellal, campholenic aldehyde, cinnamic aldehyde, hexylcinnamic aldehyde, formyl pinane, hydroxycitronellal, cuminic aldehyde, vanillin, ethylvanillin, Lilial® (3-(4-tert-butylphenyl)-2-methylpropanal, commercially available from Givandan-Roure SA, Vernier, Switzerland), Lyral® (4- and 3-(4-hydroxy-4-methylpentyl)-3-cyclohexene-1-carbaldehyde, commercially available from International Flavors and Fragrances, USA), Bourgeonal® (3-(4-tert-butylphenyl)propanal, commercially available from Quest International, Naarden, Netherlands), heliopropanal (3-(1,3-benzodioxol-5-yl)-2-methylpropanal, commercially available from Firmenich SA, Geneva, Switzerland), Zestover (2,4-dimethyl-3-cyclohexene-1-carbaldehyde, commercially available from Firmenich SA, Geneva, Switzerland), Trifernal® (3-phenylbutanal, commercially available from Firmenich SA, Geneva, Switzerland) and alpha-sinensal.

Representative fragrant components that are ketones include, but are not limited to camphor, carvone, menthone, ionones, irones, damascenones and damacones, 4-(4-hydroxy-1-phenyl)-2-butanone (raspberry ketone), and Hedione® (methyl dihydrojasmonate, commercially available from Firmenich SA, Geneva, Switzerland).

Representative fragrant components that are alkenes include, but are not limited to linalool, 1,3,5-undecatrienes, myrcene, myrcenol, dihydromyrcenol, nerolidol, sinensals, limonene, carvone, farnesenes, and other terpenes.

A listing of common fragrant components can be found in various reference sources, for example, Perfume and Flavor Chemicals, Vols. I and II; Steffen Arctander Allured Pub. Co. (1994) and Perfumes: Art, Science and Technology; Muller, P. M. and Lamparsky, D., Blackie Academic and Professional (1994), the contents of which are incorporated herein by reference. Other representative fragrant components are described in U.S. Pat. No. 6,396,026 to Pika et al. and U.S. Pat. No. 6,147,037 to Gardlim et al., the contents of which are incorporated herein by reference.

The phrase “released over a prolonged period of time,” “releases the fragrant component over a prolonged period of time,” and the like, as used herein, means that the odor of the fragrant component when applied to the skin as a part of the fragrance delivery system of the invention can be perceived, i.e., smelled, for a longer period of time than if the fragrant component was applied to the skin not as a part of the fragrance delivery system of the invention.

The term “α-hydroxy acid,” as used herein means a 2-hydroxy carboxylic acid, i.e., a carboxylic acid having a hydroxyl group attached to the carbon atom that is α to the —COOH group. Suitable α-hydroxy acids useful in the fragrance delivery system of the invention include, but are not limited to, lactic acid, glycolic acid, malic acid, citric acid, alpha-hydroxyoctanoic acid, and α-hydroxycaprylic acid, α-hydroxyoctanoic acid, and α-hydroxycaprylic acid, 2-methyl 2-hydroxypropanoic acid, 2-hydroxybutanoic acid, phenyl 2-hydroxyacetic acid, phenyl 2-methyl 2-hydroxyacetic acid, 3-phenyl 2-hydroxyacetic acid, 2-hydroxydodecanoic acid, diphenyl 2-hydroxyacetic acid, 2-hydroxy-3-methylbutanoic acid, 2-hydroxy-4-methylpentanoic acid, 2-hydroxy-2-methylbutanoic acid, 2-hydroxybutanedioic acid, 2-hydroxypropanedioic acid, 2-hydroxy-2-methylbutanedioic acid, 2-hydroxyhexanoic acid, isocitric acid, agaricic acid, quinic acid, ascorbic acid, dihydroascorbic acid, hydroxypyruvic acid, and 2-hydroxyphenyl pyruvic acid.

In one embodiment, the α-hydroxy acid is lactic acid.

In one embodiment, the α-hydroxy acid is glycolic acid.

In one embodiment, the α-hydroxy acid is salicylic acid.

The term “β-hydroxy acid,” as used herein means a 3-hydroxy carboxylic acid i.e., a carboxylic acid having a hydroxyl group attached to the carbon atom that is β to the —COOH group. Suitable β-hydroxy acids useful in the fragrance delivery system of the invention include, but are not limited to salicylic acid, 3-hydroxybutanoic acid, 3-hydroxy-4-methoxymandelic acid; and tropic acid.

The term “poly-hydroxy acid,” as used herein means a carboxylic acid that also contains at least two hydroxy groups. Suitable poly-hydroxy acid useful in the fragrance delivery system of the invention include, but are not limited to 2,3-dihydroxypropanoic acid, 2,3,4-trihydroxybutanoic acid, 2,3,4,5,6-pentahydroxyhexanoic acid, 2,3,4,5-tetrahydroxypentanoic acid; 2,3,4,5,6,7-hexahydroxyheptanoic acid; 3-(2-hydroxyphenyl)lactic acid, 3-(4-hydroxyphenyl)lactic acid; aleuritic acid; glucaric acid; galactaric acid; gulonic acid; glucoronic acid, and tartaric acid.

One of ordinary skill in the art will also understand that various hydroxy acids, such as those described in U.S. Pat. Nos. 5,547,988 and 5,422,370, are also suitable for use in the fragrance delivery system of the invention.

The phrase “salt thereof,” as used herein, means a salt prepared from the carboxylic acid and a inorganic or organic base. Suitable bases include, but are not limited to, hydroxides of alkali metals such as sodium, potassium, and lithium; hydroxides of alkaline earth metal such as calcium and magnesium; hydroxides of other metals, such as aluminum and zinc; ammonia, and organic amines, such as unsubstituted or hydroxy-substituted mono-, di-, or trialkylamines; dicyclohexylamine; tributyl amine; pyridine; N-methyl,N-ethylamine; diethylamine; triethylamine; mono-, bis-, or tris-(2-hydroxy-lower alkyl amines), such as mono-, bis-, or tris-(2-hydroxyethyl)amine, 2-hydroxy-tert-butylamine, or tris-(hydroxymethyl)methylamine, N,N,-di-lower alkyl-N-(hydroxy lower alkyl)-amines, such as N,N,-dimethyl-N-(2-hydroxyethyl)amine, or tri-(2-hydroxyethyl)amine; N-methyl-D-glucamine; and amino acids such as arginine, lysine, and the like.

The term “ester thereof,” as used herein, means an ester obtained from the carboxylic acid and an alcohol. Suitable esters include, but are not limited to methyl, ethyl, propyl, iso-propyl, butyl, and hexyl esters.

In one embodiment, the carboxylic acid is an α-hydroxy acid.

In one embodiment, the carboxylic acid is present as a salt of an α-hydroxy acid.

In one embodiment, the carboxylic acid is present as an ester of an α-hydroxy acid.

In one embodiment, the carboxylic acid is a β-hydroxy acid.

In one embodiment, the carboxylic acid is present as a salt of a β-hydroxy acid.

In one embodiment, the carboxylic acid is present as an ester of a β-hydroxy acid.

In one embodiment, the carboxylic acid is a poly-hydroxy acid.

In one embodiment, the carboxylic acid is present as a salt of a poly-hydroxy acid.

In one embodiment, the carboxylic acid is present as an ester of a poly-hydroxy acid.

In one embodiment, the carboxylic acid is glycolic acid.

In one embodiment, the carboxylic acid is present as a salt of glycolic acid.

In one embodiment, the carboxylic acid is present as an ester of glycolic acid.

In one embodiment, the carboxylic acid is lactic acid.

In one embodiment, the carboxylic acid is present as a salt of lactic acid.

In one embodiment, the carboxylic acid is present as an ester of lactic acid.

In one embodiment, the carboxylic acid is lactic acid or a salt or an ester thereof.

In one embodiment, the carboxylic acid is salicylic acid.

In one embodiment, the carboxylic acid is present as a salt of salicylic acid.

In one embodiment, the carboxylic acid is present as an ester of salicylic acid.

The term phenoxyethanol, as used herein, means 1-hydroxy-2-phenoxy ethanol, i.e., C₆H₅—CH₂—CH₂—OH.

The term ethanol, as used herein, means CH₃CH₂—OH.

Without wishing to be bound by theory, Applicant believes that the fragrance delivery system of the invention releases the fragrant component over a prolonged period of time by allowing the fragrant component to penetrate the dermis of the skin or by increasing the amount of the fragrant component that penetrates into the dermis of the skin. Once the fragrant component penetrate the dermis of the skin the fragrant component is “trapped” within the dermis of the skin and is then released slowly from the skin, i.e., more slowly than if the fragrant component was simply applied to the surface of the skin. Increased penetration of the fragrant component can be observed, for example, by measuring the rate of diffusion of the fragrant component through animal or human skin using methods well known to those skilled in the art; for example, using a diffusion cell apparatus such as described by Merritt et al., Diffusion Apparatus for Skin Penetration, J. Controlled Release, 61 (1984), the contents of which are incorporated herein by reference.

Without wishing to be bound by theory Applicant believes that the carboxylic acid or salt or ester thereof acts as an exfoliant to remove dead or dying skin cells, from at least a portion of the skin. By removing dead or dying skin cells, the fragrant component is better able to penetrate the dermis.

Without wishing to be bound by theory Applicant believes that the ethanol and phenoxyethanol also act to increase penetration of the fragrant component into the dermis of the skin. Using a combination of ethanol and phenoxyethanol is superior at increasing the penetration of the fragrant component into the dermis of the skin compared to using either ethanol and phenoxyethanol individually.

The ratio of the carboxylic acid to the phenoxyethanol ranges from about 1:1 to about 25:1, preferably about 1.2:1 to about 10:1, and more preferably is about 1.5:1.

The ratio of the phenoxyethanol to ethanol ranges from about 1:5 to about 1:200, preferably about 1:10 to about 1:100, and more preferably about 1:15.

The fragrance delivery system of the invention is typically included as part of a cosmetic formulation. Accordingly, the invention further relates to a cosmetic formulation comprising the fragrance delivery system of the invention. The cosmetic formulation of the invention includes, in addition to the fragrance delivery system, one or more additional components.

For example, the cosmetic formulation may include a cosmetically acceptable carrier. Any suitable cosmetically acceptable carrier readily apparent to those of ordinary skill in the art may be combined with the fragrance delivery system to provide the cosmetic formulation of the invention. Cosmetically acceptable carriers include, but are not limited to, hydroxypropyl cellulose, starch (corn, potato, rice, wheat), pregelatinized starch, gelatin, sucrose, acacia, alginic acid, sodium alginate, guar gum, ethyl cellulose, carboxymethylcellulose sodium, carboxymethylcellulose calcium, polyvinylpyrrolidone, methylcellulose, hydroxyproply methylcellulose, microcrystalline cellulose, polyethylene glycol, powdered cellulose, glucose, croscarmellose sodium, crospovidone, polacrilin potassium, sodium starch glycolate, tragacanth, calcium carbonate, dibasic calcium phosphate, tribasic calcium phosphate, kaolin, mannitol, talc, cellulose acetate phthalate, polyethylene phthalate, shellac, titanium dioxide, camauba wax, microcrystalline wax, calcium stearate, magnesium stearate, castor oil, mineral oil, light mineral oil, glycerin, sorbitol, mannitol, stearic acid, sodium lauryl sulfate, hydrogenated vegetable oil (e.g., peanut, cottonseed, sunflower, sesame, olive, corn, soybean), zinc stearate, ethyl oleate, ethyl laurate, agar, calcium silicate, magnesium silicate, silicon dioxide, colloidal silicon dioxide, calcium chloride, calcium sulfate, silica gel, castor oil, diethyl phthalate, glyercin, mono- and di-acetylated monoglycerides, propylene glycol, triacetin, alamic acid, aluminum monostearate, bentonite, bentonite magma, carbomer 934, carboxymethylcellulose sodium 12, carrageenan, hydroxyethyl cellulose, magnesium aluminum silicate, pectin, polyvinyl alcohol, povidine, sodium alginate, tragacanth, xanthan gum, silicones (such as cyclomethicone or a mixture of cyclopentasiloxane and dimethicone/vinyldimethicone crosspolymer), and water.

In one embodiment, the cosmetic formulation also includes water. Typically, the water, when present, is present in the cosmetic formulation in an amount ranging from about 35 to 95 percent by weight, preferably about 40 to 92 percent by weight, and most preferably about 45 to 90 percent by weight. Preferably, the water is deionized water.

The acid selected from the group consisting of an α-hydroxy acid, a β-hydroxy acid, or a poly-hydroxy acid, or a salt thereof is typically present in the cosmetic formulation in an amount ranging from about 0.1 to 6 percent by weight, preferably about 0.2 to 4 percent by weight, and more preferably about 0.5 to 3 percent by weight.

The phenoxyethanol is typically present in the cosmetic formulation in an amount ranging from about 0.1 to 5 percent by weight, preferably about 0.2 to 3 percent by weight, and more preferably about 0.3 to 2.5 percent by weight.

The ethanol is typically present in the cosmetic formulation in an amount ranging from about 1 to 50 percent by weight, preferably 3 to 40 percent by weight, and more preferably about 5 to 30 percent by weight.

One of ordinary skill in the art will readily know the amount of the fragrant component to include in the cosmetic formulations of the invention to provide an aesthetically pleasing aroma. Typically, the fragrant component is present in the cosmetic formulation of the invention in an amount ranging from about 0.01 to 20 percent by weight, preferably about 0.05 to 15 percent by weight, and more preferably about 0.1 to 5 percent by weight, and most preferably about 0.1 to 1 percent by weight.

The cosmetic formulation may also further comprise one or more additional penetration enhancers. Suitable penetration enhancers include, but are not limited to, triacetin, acetone, oleyl alcohol, tetrahydrofuryl alcohol, alkyl sulfoxides such as dimethyl sulfoxide, dimethyl acetamide, dimethyl formamide, polyethylene glycol, pyrrolidones such as polyvinylpyrrolidone, Kollidon grades (Povidone, Polyvidone), urea, and various sugar esters such as Tween 80 (polysorbate 80) and Span 60 (sorbitan monostearate). Additional penetration enhancers are disclosed in Remington: The Science and Practice of Pharmacy, 19^{th} Edition (1995), page 1583, the contents of which are incorporated herein by reference.

The cosmetic formulations may further comprise one or more moisturizing agents. The phrase “moisturizing agent,” as used herein, means any agent that facilitates hydration of the skin by inhibiting or preventing loss of water from the skin, by absorbing water from the atmosphere and hydrating the skin, or by enhancing the ability of the skin to absorb water directly from the atmosphere; or a combination thereof. Without wishing to be bound by theory it is believed that the moisturizing agent further improves the skin's ability to absorb the fragrant component. Suitable moisturizing agents include, but are not limited to, hydrophobic moisturizing agents, hydrophilic moisturizing agents, and combinations thereof. Moisturizers, when used, are typically present in an amount from about 0.01 to 20 percent by weight, preferably about 0.05 to 10 percent by weight, more preferably from about 0.1 to 5 percent by weight.

Moisturizing agents that are hydrophobic agents include, but are not limited to, ceramide, borage oil (linoleic acid), tocopherol (Vitamin E), tocopherol linoleate, dimethicone, glycerine, and mixtures thereof. Hydrophobic agents, when present, are believed to moisturize the skin by inhibiting or preventing the loss of water from the skin. The hydrophobic agent, when present, is typically present in an amount from about 0.01 to 20 percent by weight, preferably from about 0.05 to 15 percent by weight, and more preferably from about 0.1 to 5 percent by weight.

Moisturizing agents that are hydrophilic agents include, but are not limited to, hyaluronic acid, sodium peroxylinecarbolic acid (sodium PCA), wheat protein (e.g., laurdimonium hydroxypropyl hydrolyzed wheat protein), hair keratin amino acids, and mixtures thereof. Sodium chloride may also be present, particularly when hair keratin amino acids are included as a moisturizer. Hydrophilic agents, when present, are believed to moisturize the skin by absorbing moisture from the atmosphere to hydrate or facilitate hydration of the skin. The hydrophilic agent, when present, is typically present in an amount from about 0.01 to 20 percent by weight, preferably from about 0.05 to 15 percent by weight, and more preferably from about 0.1 to 5 percent by weight.

Other moisturizing agents that hydrate the skin and are useful in the cosmetic formulations of the present invention include, but are not limited to, panthenol; primrose oil; GLA 3 and other fish oils that may include, for example, the omega-3 and omega-6 oils and/or linoleic acid; and flax seed oil.

In one embodiment, the cosmetic formulation of the invention includes both a hydrophobic moisturizing agent and a hydrophilic moisturizing agent. Without wishing to be bound by theory, it is believed that hydrophobic moisturizing agent prevents the loss of water from the skin while the hydrophilic moisturizing agent absorbs moisture from the atmosphere to hydrate or facilitate hydration of the skin. The hydrophobic moisturizing agent and a hydrophilic moisturizing agent act synergistically to improve the skin's ability to absorb the fragrant component.

The cosmetic formulations may further comprise hydrogen peroxide. The hydrogen peroxide cleanses the skin and removes substances foreign to the skin and thereby improves penetration of the fragrant component into the skin.

The cosmetic formulations of the invention may further include one or more surfactants, stabilizers, preservatives, coloring agents, buffering agents, emulsifying agents, thickeners, solvents, and the like. Any cosmetically acceptable surfactant, stabilizer, preservative, coloring agent, buffering agent, emulsifying agent, thickener, or solvent can be used in the cosmetic formulations of the invention.

Suitable surfactants, include both the foaming and non-foaming type, including, but not limited to, sodium laureth sulfate, sodium laureth-13 carboxylate, disodium laureth sulfosuccinate, disodium cocoamphodiacetate, and the like, and mixtures thereof. The surfactant component can be present in an amount ranging from about 10 to 90 percent by weight, preferably about 20 to 80 percent by weight, and more preferably about 30 to 70 percent by weight.

Suitable stabilizers include, but are not limited to, glycol stearate or PEG-150 distearate. The stabilizer, when used, is typically present in an amount ranging from about 0.1 to 5 percent by weight.

Suitable preservatives include, but are not limited to, tetrasodium ethylene-diamine tetraacetic acid (EDTA), methylparaben, benzophenone-4, methylchloroisothiazolinone, methylisothiazolinone, and the like, and mixtures thereof. Preservatives, when used, are typically present in an amount ranging from about 0.01 to 6 percent by weight, preferably about 0.05 to 4 percent by weight, and more preferably from about 0.1 to 2 percent by weight.

Suitable coloring agents include FD&C Green No. 3, FD&C Violet No. 2, FD&C Yellow No. 5, FD&C Red No. 40, and the like, and mixtures thereof. The coloring agents, when used, are typically present in an amount ranging from about 0.001 to 0.1 percent by weight, and preferably from about 0.005 to 0.05 percent by weight.

In general, the cosmetic formulation is prepared by uniformly and intimately admixing the components with liquid carriers or finely divided solid carriers or both.

The cosmetic formulation may be formulated as a gel; a paste; a cream; a salve; a viscous liquid, an aerosol spray; a powder; a solution or a suspension in an aqueous liquid, a non-aqueous liquid, an oil-in-water emulsion, or a water-in-oil liquid emulsion. The cosmetic formulation is intended for application to the skin. Representative cosmetic formulations that can include the fragrance delivery system of the invention include, but are not limited to, perfumes, colognes, eau de toilettes, after-shave lotions, body lotions, sun tan lotions, hand lotions, soaps, and shampoos.

### EXAMPLES

The following examples are set forth to assist in understanding the invention and should not, of course, be construed as specifically limiting the invention described and claimed herein. Such variations of the invention including the substitution of all equivalents now known or later developed, which would be within the purview of those skilled in the art, and changes in formulation or changes in experimental design, are to be considered to fall within the scope of the invention incorporated herein.

Examples 1-7 are representative cosmetic formulations of the invention.

### Example 1

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc. of Cleveland, | |
| | Crosspolymer | OH) | |
| | Tetrasodium | Hampene 220 (commercially available from | 0.010-0.100 |
| | EDTA | Akzo Nobel Chemicals Inc. of Dobbs Ferry, | |
| | | NY) | |
| | Aminomethyl | AMP-95 | 0.050-0.500 |
| | Propanol | | |
| Part B | Propylene Glycol | Hetester PHA (commercially available from | 0.500-3.000 |
| | lsoceteth-3 Acetate | Bernel/Alzo lnt'l of San Fernando, CA) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available from | 0.100-3.000 |
| | (and) Glyceryl | Seppic S.A. of France) | |
| | Stearate | | |
| | Mangifera Indica | Mango Butter (commercially available from | 0.010-1.000 |
| | (Mango) Seed | Premier Chemicals LLC of Cleveland OH) | |
| | Butter | | |
| | Hydrogenated | Olive Butter (commercially available from | 0.010-1.000 |
| | Olive Oil | Premier Chemicals LLC) | |
| | Tocopheryl | Vitamin E Acetate (commercially available | 0.010-1.000 |
| | Acetate | from BASF Corp. of Mount Olive, NJ) | |
| Part C | SD Alcohol 40 | SD Alcohol 40 | 5.000-30.000 |
| Part D | Phenoxyethanol | Phenoxyethanol | 0.300-2.500 |
| | lsodecydexyl | lsodecydexyl Salicylate | 0.500-3.000 |
| | Salicylate | | |
| | Fragrance | Fragrance - GIVAUDAN ROURE # TG | 0.100-1.000 |
| | (Parfum) | 080053 (commercially available from | |
| | | Givaudan Fragrance Corp. of Mount Olive, | |
| | | NJ) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 2

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available | 0.010-0.100 |
| | | from Akzo Nobel Chemicals Inc.) | |
| | Aminomethyl | AMP-95 | 0.050-0.500 |
| | Propanol | | |
| Part B | Propylene Glycol | Hetester PHA (commercially available | 0.500-3.000 |
| | lsoceteth-3 Acetate | from Bernel/Alzo lnt'l) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available | 0.100-3.000 |
| | (and) Glyceryl | from Seppic S.A.) | |
| | Stearate | | |
| | Mangifera Indica | Mango Butter (commercially available | 0.010-1.000 |
| | (Mango) Seed | from Premier Chemicals LLC) | |
| | Butter | | |
| | Hydrogenated | Olive Butter (commercially available from | 0.010-1.000 |
| | Olive Oil | Premier Chemicals LLC) | |
| | Tocopheryl Acetate | Vitamin E Acetate (commercially | 0.010-1.000 |
| | | available from BASF Corp.) | |
| Part C | SD Alcohol 40 | SD Alcohol 40 | 5.000-30.000 |
| Part D | Phenoxyethanol | Phenoxyethanol | 0.300-2.500 |
| | Ethylhexyl | Ethylhexyl Salicylate | 0.500-3.000 |
| | Salicylate | | |
| | Fragrance (Parfum) | Fragrance - GIVAUDAN ROURE # TG | 0.100-1.000 |
| | | 080053 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 3

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available | 0.010-0.100 |
| | | from Akzo Nobel Chemicals Inc.) | |
| | Aminomethyl | AMP-95 | 0.050-0.500 |
| | Propanol | | |
| Part B | Propylene Glycol | Hetester PHA (commercially available | 0.500-3.000 |
| | lsoceteth-3 Acetate | from Bernel/Alzo lnt'l) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available | 0.100-3.000 |
| | (and) Glyceryl | from Seppic S.A.) | |
| | Stearate | | |
| | Mangifera Indica | Mango Butter (commercially available | 0.010-1.000 |
| | (Mango) Seed | from Premier Chemicals LLC) | |
| | Butter | | |
| | Hydrogenated | Olive Butter (commercially available from | 0.010-1.000 |
| | Olive Oil | Premier Chemicals LLC) | |
| | Tocopheryl Acetate | Vitamin E Acetate (commercially | 0.010-1.000 |
| | | available from BASF Corp.) | |
| Part C | SD Alcohol 40 | SD Alcohol 40 | 5.000-30.000 |
| Part D | Phenoxyethanol | Phenoxyethanol | 0.300-2.500 |
| | Sodium Glycolate | Sodium Glycolate | 0.500-3.000 |
| | Fragrance (Parfum) | Fragrance - GIVAUDAN ROURE # UL | 0.100-1.000 |
| | | 031652/00 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 4

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available | 0.010-0.100 |
| | | from Akzo Nobel Chemicals Inc.) | |
| | Aminomethyl | AMP-95 | 0.050-0.500 |
| | Propanol | | |
| Part B | Propylene Glycol | Hetester PHA (commercially available | 0.500-3.000 |
| | lsoceteth-3 Acetate | from Bernel/Alzo lnt'l) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available | 0.100-3.000 |
| | (and) Glyceryl | from Seppic S.A.) | |
| | Stearate | | |
| | Mangifera Indica | Mango Butter (commercially available | 0.010-1.000 |
| | (Mango) Seed | from Premier Chemicals LLC) | |
| | Butter | | |
| | Hydrogenated | Olive Butter (commercially available from | 0.010-1.000 |
| | Olive Oil | Premier Chemicals LLC) | |
| | Tocopheryl Acetate | Vitamin E Acetate (commercially | 0.010-1.000 |
| | | available from BASF Corp.) | |
| Part C | SD Alcohol 40 | SD Alcohol 40 | 5.000-30.000 |
| Part D | Phenoxyethanol | Phenoxyethanol | 0.300-2.500 |
| | Ethyl Glycolate | Ethyl Glycolate | 0.500-3.000 |
| | Fragrance (Parfum) | Fragrance - GIVAUDAN ROURE # TG | 0.100-1.000 |
| | | 080053 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 5

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available | 0.010-0.100 |
| | | from Akzo Nobel Chemicals Inc.) | |
| | Aminomethyl | AMP-95 | 0.050-0.500 |
| | Propanol | | |
| Part B | Propylene Glycol | Hetester PHA (commercially available | 0.500-3.000 |
| | lsoceteth-3 Acetate | from Bernel/Alzo lnt'l) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available | 0.100-3.000 |
| | (and) Glyceryl | from Seppic S.A.) | |
| | Stearate | | |
| | Mangifera Indica | Mango Butter (commercially available | 0.010-1.000 |
| | (Mango) Seed | from Premier Chemicals LLC) | |
| | Butter | | |
| | Hydrogenated | Olive Butter (commercially available from | 0.010-1.000 |
| | Olive Oil | Premier Chemicals LLC) | |
| | Tocopheryl Acetate | Vitamin E Acetate (commercially | 0.010-1.000 |
| | | available from BASF Corp.) | |
| Part C | SD Alcohol 40 | SD Alcohol 40 | 5.000-30.000 |
| Part D | Phenoxyethanol | Phenoxyethanol | 0.300-2.500 |
| | Sodium Salicylate | Sodium Salicylate | 0.500-3.000 |
| | Fragrance (Parfum) | Fragrance - GIVAUDAN ROURE # UL | 0.100-1.000 |
| | | 031652/00 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 6

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available from | 0.010-0.100 |
| | | Akzo Nobel Chemicals Inc.) | |
| | Aminomethyl | AMP-95 | 0.050-0.500 |
| | Propanol | | |
| Part B | Propylene Glycol | Hetester PHA (commercially available from | 0.500-3.000 |
| | lsoceteth-3 Acetate | Bernel/Alzo lnt'l) | |
| | Methylheptyl | Beantree (commercially available from | 0.500-3.000 |
| | Isostearate | Bernel/Alzo lnt'l) | |
| | Cetyl Ethylhexanoate | Bernel Ester CO (commercially available | 0.500-3.000 |
| | | from Bernel/Alzo lnt'l) | |
| | PEG-100 Stearate | Simulsol 165 (commercially available from | 0.100-3.000 |
| | (and) Glyceryl | Seppic S.A.) | |
| | Stearate | | |
| | Mangifera Indica | Mango Butter (commercially available from | 0.010-1.000 |
| | (Mango) Seed Butter | Premier Chemicals LLC) | |
| | Hydrogenated Olive | Olive Butter (commercially available from | 0.010-1.000 |
| | Oil | Premier Chemicals LLC) | |
| | Tocopheryl Acetate | Vitamin E Acetate (commercially available | 0.010-1.000 |
| | | from BASF Corp.) | |
| Part C | SD Alcohol 40 | SD Alcohol 40 | 5.000-30.000 |
| Part D | Phenoxyethanol | Phenoxyethanol | 0.300-2.500 |
| | Glycolic Acid | Glypure 70% (DuPont) | 0.500-3.000 |
| | Fragrance (Parfum) | Fragrance - GIVAUDAN ROURE # TG | 0.100-1.000 |
| | | 080053 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

### Example 7

| | Ingredient | Trade Name/Supplier | % By Weight |
|---|---|---|---|
| Part A | Water (Aqua) | Deionized Water | 46.400-92.310 |
| | Acrylates/C₁₀₋₃₀ | Pemulen TR-1 Polymer (commercially | 0.100-1.500 |
| | Alkyl Acrylate | available from Noveon Inc.) | |
| | Crosspolymer | | |
| | Tetrasodium EDTA | Hampene 220 (commercially available | 0.010-0.100 |
| | | from Akzo Nobel Chemicals Inc.) | |
| | Aminomethyl | AMP-95 | 0.050-0.500 |
| | Propanol | | |
| Part B | Propylene Glycol | Hetester PHA (commercially available | 0.500-3.000 |
| | lsoceteth-3 Acetate | from Bernel/Alzo lnt'l) | |
| | Methylheptyl | Beantree (commercially available from | 0.500-3.000 |
| | Isostearate | Bernel/Alzo lnt'l) | |
| | Cetyl | Bernel Ester CO (commercially available | 0.500-3.000 |
| | Ethylhexanoate | from Bernel/Alzo lnt'l) | |
| | PEG-100 Stearate | Simulsol 165 (commercially available | 0.100-3.000 |
| | (and) Glyceryl | from Seppic S.A.) | |
| | Stearate | | |
| | Mangifera Indica | Mango Butter (commercially available | 0.010-1.000 |
| | (Mango) Seed | from Premier Chemicals LLC) | |
| | Butter | | |
| | Hydrogenated | Olive Butter (commercially available from | 0.010-1.000 |
| | Olive Oil | Premier Chemicals LLC) | |
| | Tocopheryl Acetate | Vitamin E Acetate (commercially | 0.010-1.000 |
| | | available from BASF Corp.) | |
| Part C | SD Alcohol 40 | SD Alcohol 40 | 5.000-30.000 |
| Part D | Phenoxyethanol | Phenoxyethanol | 0.300-2.500 |
| | Salicylic Acid | Salicylic Acid | 0.500-3.000 |
| | Fragrance (Parfum) | Fragrance - GIVAUDAN ROURE # TG | 0.100-1.000 |
| | | 080053 (commercially available from | |
| | | Givaudan Fragrance Corp.) | |
| | | | 100.000% |

Procedure: Meter deionized water into the processing tank. Sprinkle-in Pemulen TR-1 Polymer. Mix until uniform. Heat to 75° C. Add the remaining Part A ingredients. Mix until uniform. In a separate tank, heat Part B ingredients to 75° C. Mix until uniform. When both Parts A and B are at 75° C., add Part B to Part A. Mix for 15 minutes at 75° C. until uniform. Cool to 35° C. At 35° C., add Part C. Mix until uniform. Add premixed Part D. Mix until uniform.

| | |
|---|---|
| Appearance: | Colorless, clear to slightly hazy, slightly viscous liquid |
| pH at 25° C.: | 4.00-7.00 |
| Viscosity: | 3,000-4,000 cps. (RVT: #4 spindle at 10 rpm) |

The present invention is not to be limited in scope by the specific embodiments disclosed in the examples which are intended as illustrations of a few aspects of the invention and any embodiments that are functionally equivalent are within the scope of the invention. Indeed, various modifications of the invention in addition to those shown and described herein will become apparent to those skilled in the art and are intended to fall within the scope of the appended claims.

A number of references have been cited, the entire disclosure of which are incorporated herein by reference.

What is claimed is:

1. A fragrance delivery system comprising (i) a fragrant component; (ii) a carboxylic acid or a salt or ester thereof, wherein the carboxylic acid is selected from the group consisting of an α-hydroxy acid, a β-hydroxy acid, or a poly-hydroxy acid; (iii) phenoxyethanol; and (iv) ethanol.

2. The fragrance delivery system of claim 1, wherein the carboxylic acid is an α-hydroxy acid or a salt or ester thereof.

3. The fragrance delivery system of claim 1, wherein the carboxylic acid is a β-hydroxy acid or a salt or ester thereof.

4. The fragrance delivery system of claim 1, wherein the carboxylic acid is a poly-hydroxy acid or a salt or ester thereof.

5. The fragrance delivery system of claim 1, wherein the ratio of the carboxylic acid to phenoxyethanol ranges from about 1:1 to about 25:1 and the ratio of phenoxyethanol to ethanol ranges from about 1:5 to about 1:200.

6. A cosmetic formulation comprising the fragrance delivery system of claim 1 and a cosmetically acceptable carrier.

7. The cosmetic formulation of claim 6, wherein the cosmetically acceptable carrier comprises water.

8. The cosmetic formulation of claim 7, wherein the water is present in an amount ranging from about 5 to 95 percent by weight.

9. The cosmetic formulation of claim 6, wherein the carboxylic acid or a salt thereof is present in an amount ranging from about 0.1 to 6 weight percent, the phenoxyethanol is present in an amount ranging from about 0.1 to 5 weight percent, and the ethanol is present in an amount ranging from about 1 to 50 weight percent.

10. The cosmetic formulation of claim 7, wherein the fragrant component is present in an amount ranging from about 0.01 to 20 percent by weight.

11. The cosmetic formulation of claim 6 further comprising a moisturizing agent.

12. The cosmetic formulation of claim 11, wherein the moisturizing agent is a hydrophobic moisturizing agent.

13. The cosmetic formulation of claim 11, wherein the moisturizing agent is a hydrophilic moisturizing agent.

14. The cosmetic formulation of claim 11, comprising hydrophobic moisturizing agent and a hydrophilic moisturizing agent.

15. The cosmetic formulation of claim 6 formulated as a gel; a paste; a cream; a salve; a viscous liquid, an aerosol spray; a powder; a solution or a suspension in an aqueous liquid, a non-aqueous liquid, an oil-in-water emulsion, or a water-in-oil liquid emulsion, containing the fragrance delivery system.

16. The cosmetic formulation of claim 15 formulated as an aerosol.

17. The cosmetic formulation of claim 15 formulated as a viscous liquid.

18. The fragrance delivery system of claim 1, wherein the carboxylic acid is glycolic acid or a salt or ester thereof.

19. The fragrance delivery system of claim 1, wherein the carboxylic acid is lactic acid or a salt or ester thereof.

20. The fragrance delivery system of claim 1, wherein the carboxylic acid is salicylic acid or a salt or ester thereof.
